(19) United States
(12) Patent Application Publication
(10) Pub. No.: US 2023/0291724 A1
(43) Pub. Date: Sep. 14, 2023

(54) METHOD AND SYSTEM FOR AUTHENTICATING A USER IN A SESSION INITIATED ON A COMPUTING DEVICE

(71) Applicant: Singapore University of Technology and Design, Singapore (SG)

(72) Inventors: Tony Quee Seng QUEK, Singapore (SG); Jianying ZHOU, Singapore (SG); Lucienne Theresia Maria BLESSING, Singapore (SG); Jay PRAKASH, Singapore (SG); Andrei BYTES, Singapore (SG)

(21) Appl. No.: 18/040,482

(22) PCT Filed: Aug. 4, 2021
(86) PCT No.: PCT/SG2021/050454

§ 371 Date: Feb. 3, 2023

(30) Foreign Application Priority Data
Aug. 6, 2020 (SG) 10202007560Y

(51) Int. Cl. H04L 9/40

(52) U.S. Cl. CPC H04L 63/0807; H04L 2463/082

(57) ABSTRACT

A method for authenticating a user in a session initiated on a computing device is disclosed herein. In a specific embodiment, the method comprises identifying a selection of an authentication verifier (801, 1101, 1205, 1305, 1405, 1505) from a set of possible authentication verifiers for the session, the selected authentication verifier (801, 1101, 1205, 1305, 1405, 1505) being 10 communicated within the session to the session user; identifying an authentication device (17) associated with an identifier for the session; providing at least two of the set of possible authentication verifiers for selection at the authentication device (17) for the session, the at least two of the set of possible authentication verifiers including the selected authentication verifier (801, 1101, 15 1205, 1305, 1405, 1505); receiving an authentication device selection from the authentication device (17) by a user’s selection from the at least two of the set of possible authentication verifiers; and determining if the authentication device selection matches the selected authentication verifier (801, 1101, 1205, 1305, 1405, 1505) as communicated within the session. A system for authenticating 20 the user in the session is also disclosed.

### BACKGROUND AND FIELD

The present disclosure relates to a method and system for authenticating a user in a session initiated on a computing device, in particular, but not exclusively, for use as part of a two-factor authentication (TFA) process.

Two-factor authentication (TFA) and password-less authentication have witnessed a sharp rise in adoption in the past few years. In some such approaches to authentication, a device is first enrolled as a token device and associated with an (account, service) pair. Next, whenever a user attempts to log in to an application or web-service associated with the account, information received or transmitted by the token device is required to gain access.

Existing token-based approaches to two-factor authentication (TFA) and password-less authentication are typically cumbersome for the user to employ, giving rise to a high error rate, and/or suffer from security vulnerabilities.

It is desirable to provide a method and system for authenticating a user in a session which addresses at least one of the drawbacks of the prior art and/or to provide the public with a useful choice.

### SUMMARY

In a first aspect, there is provided a method of authenticating a session user in a session initiated on a computing device. The method comprises: identifying a selection of an authentication verifier from a set of possible authentication verifiers for the session, the selected authentication verifier being communicated within the session to the session user; identifying an authentication device associated with an identifier for the session; providing at least two of the set of possible authentication verifiers for selection at the authentication device for the session, the at least two of the set of possible authentication verifiers including the selected authentication verifier; receiving an authentication device selection from the authentication device by a user’s selection from the at least two of the set of possible authentication verifiers; and determining if the authentication device selection matches the selected authentication verifier as communicated within the session.

Providing at least two of the set of possible authentication verifiers for selection at the authentication device for the session may mean that only the session user (to whom the authentication verifier was communicated in the session) will know the correct authentication verifier to select on the authentication device. Thus, this may ensure that only the legitimate user (who is in possession of the authentication device) is authenticated, thereby improving security.

Preferably, identifying the selection of the authentication verifier from the set of possible authentication verifiers for the session may include selecting the authentication verifier from the set of possible authentication verifiers for the session, for example, randomly selecting the authentication verifier from the set of possible authentication verifiers for the session. Alternatively, the authentication verifier may be selected by the session user and the method may include receiving the selection of the authentication verifier by the session user.

In a specific embodiment, providing at least two of the set of possible authentication verifiers for selection at the authentication device for the session may comprise providing from about 8 to about 100 of the set of possible authentication verifiers for selection at the authentication device. Further, providing at least two of the set of possible authentication verifiers for selection at the authentication device for the session may comprise providing a graphical user interface operable to receive the authentication device selection. Advantageously, the graphical user interface may be provided in the form of an interactive push overlay notification to the authentication device.

Preferably, each of the set of possible authentication verifiers may comprise a different respective drag direction for at least one object, and providing at least two of the set of possible authentication verifiers for selection at the authentication device for the session may comprise providing the at least one object for display at the authentication device, for example, but not limited to, as part of a graphical user interface. Each of the set of possible authentication verifiers may also comprise a respective drag direction for a respective object of a plurality of objects, and providing at least two of the set of possible authentication verifiers for selection at the authentication device may comprise providing the plurality of objects for display at the authentication device.

In a specific embodiment, each of the set of possible authentication verifiers may comprise a different respective number and providing at least two of the set of possible authentication verifiers for selection at the authentication device may comprise providing an interface operable to receive a numerical input at the authentication device, for example a numerical keypad for display at the authentication device, for example but not limited to as part of a graphical user interface.

It is also envisaged that each of the set of possible authentication verifiers may comprise a different respective button of a plurality of buttons and providing at least two of the set of possible authentication verifiers for selection at the authentication device may comprise providing at least two of the plurality of buttons for display at the authentication device, for example but not limited to as part of a graphical user interface.

Preferably, each of the set of possible authentication verifiers may comprise a different respective pattern and providing at least two of the set of possible authentication verifiers for selection at the authentication device may comprise providing an interface operable to receive a user drawing of a selected pattern at the authentication device, for example, but not limited to a graphical user interface.

Each of the set of possible authentication verifiers may comprise a different respective location on the authentication device to be tapped.

Specifically, the method may further comprise selecting the set of possible authentication verifiers from a superset comprising a plurality of sets of possible authentication verifiers.

In a specific embodiment, the authentication device may comprise at least one inertial measuring unit (IMU) and receiving an authentication device selection from the authentication device may include receiving data from the at least one inertial measuring unit. It is also envisaged that the authentication device may comprise a plurality of inertial measuring units and receiving an authentication device selection from the authentication device may include receiving data from each of the plurality of the inertial measuring units.

It should be appreciated that the authentication device may or may not comprise a token device, and the computing device may or may not comprise one of a mobile device and a personal computer. It is also possible that the identifier for the session may comprise at least one of a username and a password.

In a second aspect, there is provided an authentication server for authenticating a session user in a session initiated on a computing device, the authentication server comprising at least one processor configured to: identify a selection of an authentication verifier from a set of possible authentication verifiers for the session, the selected authentication verifier being communicated within the session to the session user; identify an authentication device associated with an identifier for the session; provide at least two of the set of possible authentication verifiers for selection at the authentication device for the session, the at least two of the set of possible authentication verifiers including the selected authentication verifier; receive an authentication device selection from the authentication device by a user’s selection from the at least two of the set of possible authentication verifiers; and determine if the authentication device selection matches the selected authentication verifier as communicated within the session.

In a third aspect, there is provided a method of authenticating a session user in a session initiated on a computing device, the method comprising: identifying, by an authentication server, an authentication device associated with an identifier for the session; identifying, by the authentication server, a selection of an authentication verifier from a set of possible authentication verifiers for the session; communicating, by the authentication server, the selected authentication verifier within the session to the computing device of the session user; providing at least two of the set of possible authentication verifiers by the authentication server including the selected authentication verifier for selection at the authentication device; receiving, by the authentication device, an authentication device selection by a user’s selection from the at least two of the set of possible authentication verifiers; receiving, by the authentication server, the authentication device selection from the authentication device; and determining, by the authentication server, if the authentication device selection matches the selected authentication verifier as communicated within the session. The method may further comprise selecting, by the user, the authentication device selection.

In particular, selecting, by the user, the authentication device selection may include one or more of: dragging a displayed object in a user selected drag direction, inputting a user selected number at the authentication device, tapping a user selected button of at least two displayed buttons, drawing a user selected pattern and tapping on a user selected location on the authentication device, in accordance with the set of possible authentication verifiers.

In a specific embodiment, each of the set of possible authentication verifiers may comprise a different respective drag direction for an object, and providing at least two of the set of possible authentication verifiers for selection at the authentication device may comprise providing the at least one object for display at the authentication device. Correspondingly, selecting, by the user, the authentication device selection may comprise dragging the displayed object in a user selected drag direction.

It is also envisaged that providing the at least two each of the set of possible authentication verifiers for selection at the authentication device may comprise providing an interface operable to receive a numerical input at the authentication device. Correspondingly, selecting, by the user, the authentication device selection may comprise inputting a user selected number at the authentication device.

In a further specific embodiment, each of the set of possible authentication verifiers may comprise a different respective button and providing at least two of the set of possible authentication verifiers for selection at the authentication device may comprise providing at least two of the different respective buttons for display at the authentication device. In this specific embodiment, selecting, by the user, the authentication device selection may comprise tapping a user selected button of the displayed at least two different respective buttons. It is also possible that each of the set of possible authentication verifiers may comprise a different respective pattern and wherein providing at least two of the set of possible authentication verifiers for selection at the authentication device may comprise providing an interface operable to receive a user drawing of a user selected pattern at the authentication device. Specifically, selecting, by the user, the authentication device selection may correspondingly comprise drawing the user selected pattern.

Yet further, it is envisaged that each of the set of possible authentication verifiers may comprise a different respective location on the authentication device, in which case, selecting, by the user, the authentication device selection may comprise tapping on a user selected location on the authentication device.

In a fourth aspect, there is provided a system for authenticating a session user in a session, the session comprising an identifier, the system comprising: a computing device configured to initiate the session; an authentication device associated with the identifier; and an authentication server communicatively coupled to the computing device and the authentication device, and configured to: identify the authentication device from the identifier for the session, identify a selection of an authentication verifier from a set of possible authentication verifiers for the session, communicate the selected authentication verifier within the session to the computing device of the session user; communicate at least two of the set of possible authentication verifiers including the selected authentication verifier to the authentication device for selection at the authentication device; wherein the authentication device is arranged to receive a user’s selection of an authentication device selection from the at least two of the set of possible authentication verifiers and to communicate the authentication device selection to the authentication server; and wherein, the authentication server is further configured to determine if the authentication device selection matches the selected authentication verifier as communicated within the session.

Advantageously, the authentication device may comprise at least one inertial measuring unit (IMU) and the authentication device may be configured to detect the user’s selection of an authentication device selection using the at least one inertial measuring unit (IMU). It is also envisaged that the authentication device may be arranged to display a graphical user interface and to receive the user’s selection of an authentication device selection via an interaction of the user with the graphical user interface.

In particular, the authentication device may be arranged to detect one or more of: dragging of a displayed object by the user in a user selected direction; an input of a user selected number by a user; tapping of a user selected button of at least two displayed buttons by the user; and tapping of a user selected location on the authentication device by the user, in accordance with the set of possible authentication verifiers.

Specifically, each of the set of possible authentication verifiers may comprise a different respective drag direction for an object, and the authentication device may be arranged to display the object and to detect dragging of the displayed object by the user in a user selected direction.

It is also envisaged that each of the set of possible authentication verifiers may comprise a different number and that the authentication device may be arranged to detect an input of a user selected number by the user.

In a further specific embodiment, each of the set of possible authentication verifiers may comprise a different respective button and the authentication device may be arranged to display at least two of the different respective buttons and to detect tapping of a user selected button of the displayed at least two of the different respective buttons by the user.

It is also possible that each of the set of possible authentication verifiers may comprise a different respective pattern and the authentication device may be arranged to detect drawing of a user selected pattern by the user.

Yet further, it is envisaged that each of the set of possible authentication verifiers may comprise a different respective location on the authentication device and the authentication device may be arranged to detect tapping of a user selected location on the authentication device by the user.

It should be appreciated that the authentication device may or may not comprise a token device. It is also possible that the system further comprises an application server operable to host the session.

In a fifth aspect, there is provided a computer-readable medium storing instructions which when executed by a processor cause the processor to identify a selection of an authentication verifier from a set of possible authentication verifiers for the session, the selected authentication verifier being communicated within the session to the session user; identify an authentication device associated with an identifier for the session; provide at least two of the set of possible authentication verifiers for selection at the authentication device for the session, the at least two of the set of possible authentication verifiers including the selected authentication verifier; receive an authentication device selection from the authentication device by a user’s selection from the at least two of the set of possible authentication verifiers; and determine if the authentication device selection matches the selected authentication verifier as communicated within the session. It should be appreciated that the computer-readable medium may be tangible or intangible.

In a sixth aspect, there is provided a computer-readable medium storing instructions configured to cause a system comprising a computing device, an authentication server, and an authentication device to: identify, by an authentication server, an authentication device associated with an identifier for the session; identify, by the authentication server, a selection of an authentication verifier from a set of possible authentication verifiers for the session; communicate, by the authentication server, the selected authentication verifier within the session to the computing device of the session user; provide at least two of the set of possible authentication verifiers by the authentication server including the selected authentication verifier for selection at the authentication device; receive, by the authentication device, an authentication device selection by a user’s selection from the at least two of the set of possible authentication verifiers; receive, by the authentication server, the authentication device selection from the authentication device; and determine, by the authentication server, if the authentication device selection matches the selected authentication verifier as communicated within the session. It should be appreciated that the computer-readable medium may be tangible or intangible.

It is envisaged that features relating to one aspect may be applicable to the other aspects.

### BRIEF DESCRIPTION OF THE DRAWINGS

Exemplary embodiments will now be described with reference to the accompanying drawings, in which:

FIG. 1 illustrates a system for authenticating a user of a session initiated on a computing device according to a first embodiment;

FIG. 2 illustrates a block diagram of a computer system suitable for use in one of the components of the system of FIG. 1;

FIG. 3 illustrates a block diagram of a token device of the system of FIG. 1;

FIG. 4 illustrates a software environment that may be implemented in the token device of FIG. 3;

FIG. 5 illustrates an alternative software environment that may be implemented in the token device of FIG. 3;

FIG. 6 illustrates a protocol for authenticating a user performed by the system of FIG. 1;

FIG. 7 illustrates a set of authentication verifiers for use in the protocol of FIG. 6;

FIG. 8 is a summary of the steps performed by an authentication server of the system of FIG. 1 during the protocol of FIG. 6;

FIG. 9 illustrates an exemplary protocol for enrollment of the token device of FIG. 3;

FIGS. 10a and 10b show a user computing display and interactive push overlay, respectively to illustrate a set of authentication verifiers according to a second embodiment;

FIGS. 11a and 11b show a user computing display and interactive push overlay, respectively to illustrate a set of authentication verifiers according to a third embodiment;

FIGS. 12a and 12b show a user computing display and interactive push overlay, respectively to illustrate a set of authentication verifiers according to a fourth embodiment;

FIGS. 13a and 13b show a user computing display and interactive push overlay, respectively to illustrate a set of authentication verifiers according to a fifth embodiment;

FIGS. 14a and 14b show a user computing display and interactive push overlay, respectively to illustrate a set of authentication verifiers according to a sixth embodiment; and

FIGS. 15a and 15b show a system for authenticating a user of a session initiated on a computing device and a corresponding token device, respectively, to illustrate a set of authentication verifiers according to an eight embodiment.

### DETAILED DESCRIPTION OF FIRST EMBODIMENT

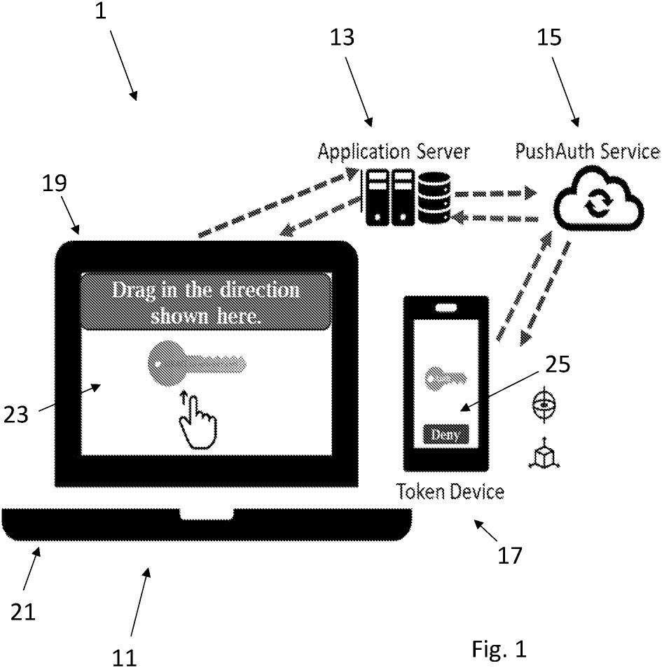

FIG. 1 illustrates a system 1 for authenticating a user of a session initiated on a computing device according to a first embodiment.

The system 1 comprises a user computing device 11, in the form of a personal computer comprising a display screen 19 and a keyboard 21; an authentication server 15 which, in the described embodiment, comprises one or more computing devices cooperating as a cloud computing environment; and an authentication device in the form of a token device 17, which in the described embodiment comprises a mobile phone (smartphone). The term token device as used herein is intended to denote a peripheral device with no physical connection to the user computing device 11.

The token device 17 includes a touch screen 25. The user computing device 11, and token device 17 are both in two-way communication with the authentication server 15 via a network, for example the internet. In the described embodiment, the system 1, further includes an application server 13 itself comprising one or more computing devices, and the user computing device 11 and authentication server 15 are in two-way communication via the application server 13.

Authentication instructions 23 are displayed as text and images in a webpage on the screen 19 of the user computing device 11 within a web browser, the webpage being hosted by the application server 13. A user interface in the form of a push notification overlay is displayed on the touch screen 25 of the token device 17.

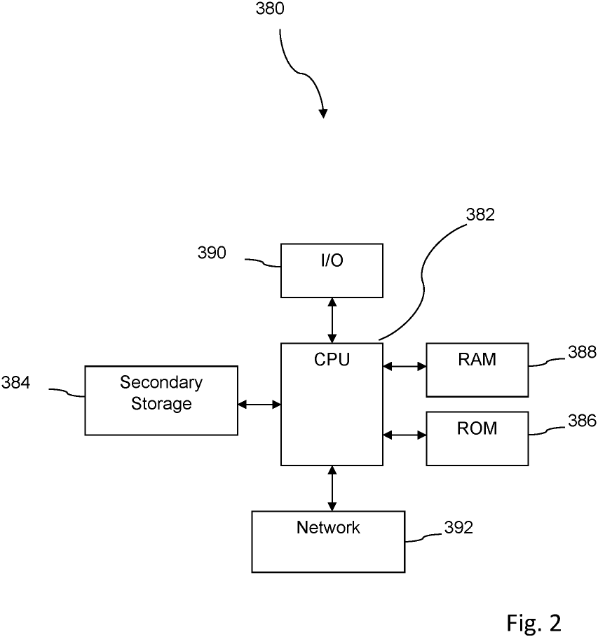

FIG. 2 is a block diagram of a computer system 380 suitable for use as the user computing device 11, as one of the one or more computing devices employed in the application server 13 and/or as one of the computing devices comprised within the authentication server 15. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

In the described embodiment, a program in the form of a web browser application may be stored in a memory device of the user computing device 11. A program in the form of a web application may be stored in the memory devices of the application server 13 enabling the application server 13 to host the web application by executing the web application on CPU 382 of the application server 13. A software module for performing a user authentication method in accordance to the described embodiment may be stored in the memory devices of at least one computing device comprised within the authentication server 15 and, when executed on one or more of the processors of the authentication server 15, causes them to perform some or all of the user authentication steps described herein.

I/O devices 390 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 392 may enable the processor 382 to communicate with the Internet or one or more intranets. With such a network connection, it is contemplated that the processor 382 might receive information from the network, or might output information to the network in the course of engaging in the two-way communication as described above and shown schematically in FIG. 1 including, but not limited to performing method steps described below.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

The computer system 380 may provide hardware and/or firmware to assist carrying out a variety of secure transactions, secure communications, or to enhance security of transactions and/or communications. For example, the computer system 380 may comprise one or more secure elements (SE) coupled to a near field communication (NFC) transceiver. The SE may be provisioned with an initial electronic fund balance (e.g., electronic money) and/or secure information such as credit card numbers and authentication numbers or codes. When the NFC engages with a point-of-sale (POS) terminal or other wireless communication device, the NFC may access the SE to debit funds stored in the SE during a purchase transaction or increment funds stored in the SE during a “top up” transaction (e.g., to add or deposit additional funds into the electronic funds balance). In at least some embodiments, the only communication between the SE and the exterior world may be via the NFC. In at least some embodiments, there is no communication between the SE and the remainder of the computer system 380.

In an embodiment, the computer system 380 may comprise two or more computers in communication with each other that collaborate to perform a task, for example in the cloud computing environment comprising the authentication server 15. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers.

In an embodiment, instead of, or in addition to the functionality of the authentication server 15 being provided by executing the application and/or applications in a cloud computing environment, as in the described embodiment, the functionality of the user computing device 11 and/or the application server 13 may also be provided by executing an application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the authentication enterprise as well as cloud computing resources hired and/or leased from a third party provider.

In an embodiment, some or all of the functionality of the user computing device 11, application server 13 and the authentication server 15 described herein may be provided as a computer program product. The computer program product may comprise one or more computer readable storage medium having computer usable program code embodied therein to implement the functionality disclosed herein. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

The token device 17 may take various forms in addition to a mobile phone including a wireless handset, a pager, a personal digital assistant (PDA), a gaming device, a media player, a tablet, a wearable computer, a headset computer, or the like. The token device 17 includes a display 25 and a touch-sensitive surface and/or keys for input by a user. The token device 17 may present options for the user to select, controls for the user to actuate, and/or cursors or other indicators for the user to direct. The token device 17 may further accept data entry from the user, including numbers to dial or various parameter values for configuring the operation of the handset. The token device 17 may further execute one or more software or firmware applications in response to user commands. These applications may configure the token device 17 to perform various customized functions in response to user interaction. Additionally, the token device 17 may be programmed and/or configured over-the-air, for example from a wireless base station, a wireless access point, or a peer token device 17. The token device 17 may execute a web browser application which enables the touch screen 25 to show a web page. The token device 17 may execute an application which enables the touch screen 25 to show a push notification. The web page or push notification may be obtained via wireless communications with a base transceiver station, a wireless network access node, the authentication server 15, a peer token device or any other wireless communication network or system.

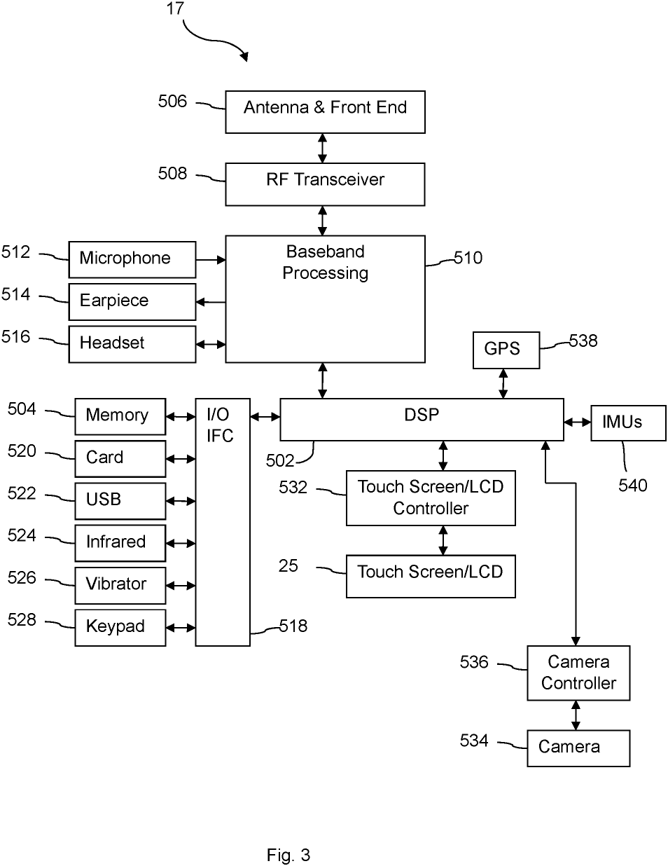

FIG. 3 shows an exemplary block diagram of the token device 17. While a variety of known components of handsets are depicted, in an embodiment a subset of the listed components and/or additional components not listed may be included in the token device 17. In an embodiment, the token device 17 includes a digital signal processor (DSP) 502 and a memory 504. As shown, the token device 17 may further include an antenna and front end unit 506, a radio frequency (RF) transceiver 508, a baseband processing unit 510, a microphone 512, an earpiece and/or speaker 514, a headset port 516, an input/output interface 518, a removable memory card 520, a universal serial bus (USB) port 522, an infrared port 524, a vibrator 526, a keypad 528, the touch screen 25 with a touch sensitive surface, a touch screen controller 532, a camera 534, a camera controller 536, a global positioning system (GPS) receiver 538, and inertial measuring units (IMUs) 540 (equivalently inertial measurement units) such as an accelerometer (e.g., a single or multi axis accelerometer), a gyroscope, and the like. In an embodiment, the token device 17 may include another kind of display that does not provide a touch sensitive screen. In an embodiment, the DSP 502 may communicate directly with the memory 504 without passing through the input/output interface 518. Additionally, in an embodiment, the token device 17 may comprise other peripheral devices that provide other functionality.

The DSP 502 or some other form of controller or central processing unit operates to control the various components of the token device 17 in accordance with embedded software or firmware stored in memory 504 or stored in memory contained within the DSP 502 itself. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, including functionality in accordance with embodiments described herein, or the application software may be high-level software instructions to be processed by an interpreter or compiler to indirectly configure the DSP 502.

The DSP 502 may communicate with a wireless network via the analog baseband processing unit 510, including in the course of engaging in the two-way communication with the authentication server 15 as described above in relation to FIG. 1 and described in further detail below. In some embodiments, the communication with the wireless network may provide Internet connectivity, enabling a user to gain access to content on the Internet and to send and receive e-mail, text messages, or push-notifications as will be described below. The input/output interface 518 interconnects the DSP 502 and various memories and interfaces. The memory 504 and the removable memory card 520 may provide software and data to configure the operation of the DSP 502. Among the interfaces may be the USB port 522 and the infrared port 524. The USB port 522 may enable the token device 17 to function as a peripheral device to exchange information with a personal computer or other computer system. The infrared port 524 and other optional ports such as a Bluetooth interface or an IEEE 802.11 compliant wireless interface may enable the token device 17 to communicate wirelessly with other nearby handsets and/or wireless base stations. In an embodiment, the token device 17 may comprise a near field communication (NFC) transceiver. The NFC transceiver may be used to complete payment transactions with point-of-sale terminals or other communications exchanges. In an embodiment, the token device 17 may comprise a radio frequency identity (RFID) reader and/or writer device.

The RF transceiver 508 may also be referred to as a radio transceiver, or more concisely, as a radio. While one RF transceiver 508 is illustrated, the token device 17 may comprise a plurality of radio transceivers, for example, different RF transceivers 508 associated with different wireless communication protocols and/or different frequency bands. Alternatively, the RF transceiver 508 may be a multi-protocol and/or multi-band RF transceiver.

The token device 17 includes the touch screen 25 which functions as an input mechanism, and which may also display text and/or graphics to the user. The touch screen controller 532 couples the DSP 502 to the touch screen 25. The token device 17 may further comprise a keypad 528 which couples to the DSP 502 via the input/output interface 518 to provide another mechanism for the user to make selections, enter information, and otherwise provide input to the token device 17. The GPS receiver 538 is coupled to the DSP 502 to decode global positioning system signals, thereby enabling the token device 17 to determine its position.

In an embodiment, the token device 17 may provide hardware and/or firmware to assist carrying out a variety of secure transactions, secure communications, or to enhance security of transactions and/or communications. As another example, the token device 17 may comprise one or more secured (e.g., encrypted) or trusted elements. The secured elements may be implemented in hardware or virtually by an operating system environment. When secured processing is performed, non-secured processing may be completely stopped, whereby screen scraping, memory bus eavesdropping, and the like by a corrupt or malicious untrusted process may be avoided. In an embodiment, security tokens may be stored in a trusted partition of memory, and access to read and write these areas of memory from an external source, for example from a credit card issuer or a trusted service manager, may be secured by presentation of the trust token.

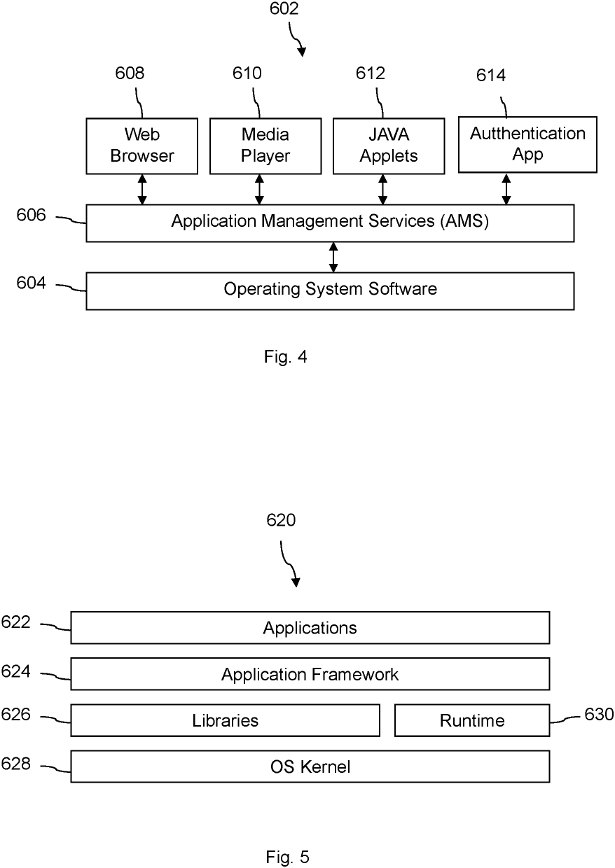

FIG. 4 illustrates a software environment 602 that may be implemented by the DSP 502. The DSP 502 executes operating system software 604 that provides a platform from which the rest of the software operates. The operating system software 604 may provide a variety of drivers for the handset hardware using interfaces that are accessible to application software. The operating system software 604 may be coupled to and interact with application management services (AMS) 606 that transfer control between applications running on the token device 17. Also shown in FIG. 4 are a web browser application 608, a media player application 610, and JAVA applets 612. The web browser application 608 may be executed by the token device 17 to browse content and/or the Internet, for example when the token device 17 is coupled to a network via a wireless link. The web browser application 608 may permit a user to enter information into forms and select links to retrieve and view web pages. The media player application 610 may be executed by the token device 17 to play audio or audiovisual media. The JAVA applets 612 may be executed by the token device 17 to provide a variety of functionality including games, utilities, and other functionality.

In the described embodiment, the software environment 602 further includes an authentication application 614 the functionality of which, when executed by the DSP 502, will be described below. The authentication application 614 may enable interactive push overlay notifications to be displayed on the touch screen 25. For example, the authentication application 614 may be a cloud messaging client application such as a Firebase cloud messaging client application.

FIG. 5 illustrates an alternative software environment 620 that may be implemented by the DSP 502. The DSP 502 executes operating system kernel (OS kernel) 628 and an execution runtime 630. The DSP 502 executes applications 622 that may execute in the execution runtime 630 and may rely upon services provided by the application framework 624. Applications 622 and the application framework 624 may rely upon functionality provided via the libraries 626.

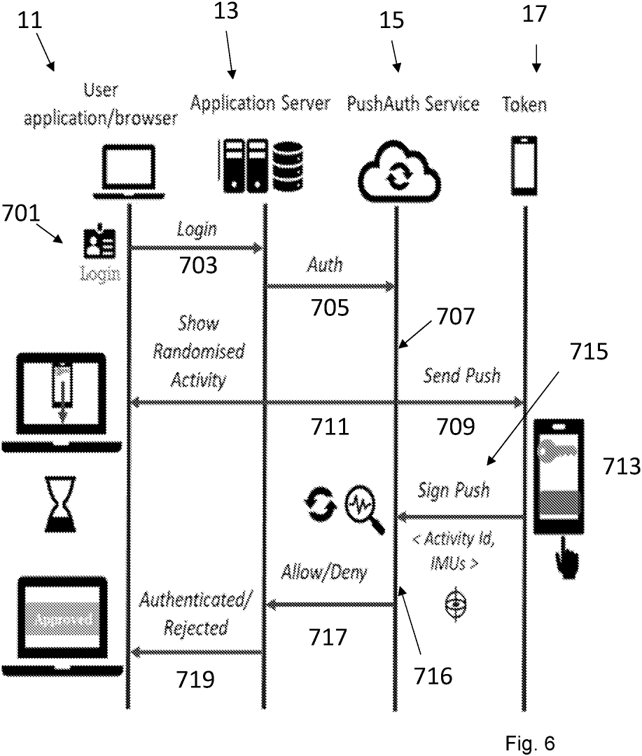

FIG. 6 illustrates a protocol for authenticating a user performed by the system 1. In step 701, a user initiates a session of, for example, a web application hosted on application server 13, using the web browser software stored in the memory devices of the user computing device 11 and executed on the CPU 382. In the described embodiment, the CPU 382 of the user computing device 11 receives instructions for a login page for display in the web browser from the application server 13 via their respective network connectivity devices 392 and the user inputs login credentials for the web application into the login page, for example a username and password which function as identifiers for the session.

In step 703, these login credentials are transmitted to the application server 13 via the respective network connectivity devices 392 of the user computing device 11 and the application server 13. The application server 13 checks these login credentials, for example against a database of login credentials for authorized users stored in the memory devices of the application server 13 by executing a software module on the CPU 382 of the application server 13.

If the login credentials received by the application server 13 correspond to those of an authorized user, in step 705, the software module of application server 13 causes details of the authorized user to the authentication server 15 to be transmitted (for example, via the respective network connectivity devices 392 of the application server 13 and one of more of the computing devices in the cloud environment comprising the authentication server 15) including sufficient details enabling the authentication server 15 to identify the token device 17.

In step 707, a software module of authentication server 15 is executed and correspondingly looks up the token device 17 associated with the authorized user, for example on a database of login credentials and corresponding token devices 17 stored in the memory devices of the authentication server 15.

The authentication server also executes the software module for performing the user authentication method (which may, for example, be the same as the software module for looking up the token device) on one or more CPUs 382 which selects an authentication verifier from a set of possible authentication verifiers.

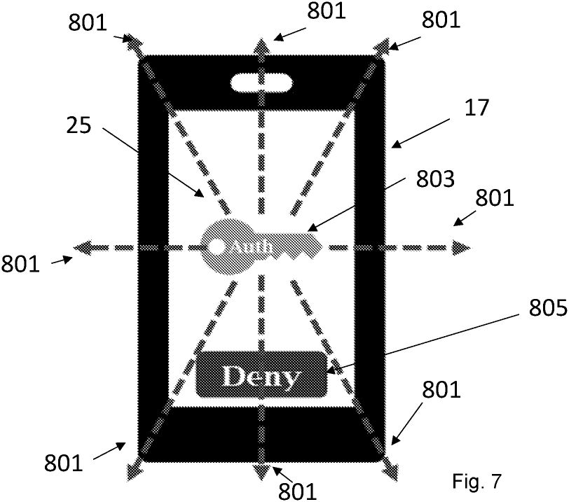

In the described embodiment, the authentication verifier is an interaction, equivalently activity, to be performed in a graphical user interface, in the form of interactive push overlay to be sent to the token device 17. Specifically, in the described embodiment, the authentication verifier comprises the dragging by the user (via the touch screen 25 of the token device 17) of an object in the form of a key icon 803 in a particular direction. In the described embodiment, the set of possible authentication verifiers from which the authentication verifier is chosen is an activity set comprising eight different drag directions 801 for dragging the key icon 803 as illustrated in FIG. 7.

In the described embodiment, the drag direction 801 chosen as the selected authentication verifier is chosen randomly, for example using random number generator software executed on a CPU 382 of the authentication server 15 which may form part of the software module for performing the user authentication, or may be a separate software module. Such software may generate a sequence of numbers, and the CPU 382 may interpret each number as corresponding to one of the drag directions 801 of the activity set.

Note that the term “randomly” as used herein is intended to encompass both pseudo-randomly, for example as determined algorithmically (using, for example, random number software stored in a memory device of the authentication server 15 and executed on a processor 382 of the authentication server 15), and truly randomly, for example by measuring a physical quantity.

The selected drag direction is stored in one of the memory devices of the authentication server 15 for use in step 717 described below.

In step 709, the authentication server 15 sends a push command to the token device 17, for example via the network connectivity devices 392 of one of the computing resources of the authentication server 15. This may be performed by executing push notification software such as, for example, Firebase cloud messaging on one or more CPUs 382 of the authentication server 15. The corresponding authentication application software 614 executed on the DSP 502 causes an interactive push overlay to be displayed to the user on the touch screen 25 of the token device 17 upon receipt of the push command, for example via the analog baseband processing unit 510. An example of the interactive push overlay is shown in FIG. 7 (the arrows are for illustration only and are not displayed on touch screen 25 of the token device 17). The interactive push overlay provides a user interface (Ul) which includes a key icon 803 as an object which may be dragged in a particular direction on the touch screen 25 by the user moving their finger in contact with an across the touch screen 25. The interactive push overlay further includes a “Deny” button icon 805 which the user can select by touching the screen over the icon 805, for example, in the case that they did not attempt to log in into the web application and do not wish to authorize the session.

Thus, the push notification provides the set of drag directions for selection by the user at the token device 17.

In step 711, at approximately the same time that the push command is sent to the token device 17, the authentication server 15 sends details of the randomly selected drag direction (i.e. the selected authentication verifier) to the application server 13 and the web application executed on CPU 382 of the application server 13 causes details of the selected drag direction 801 to be displayed in the web browser of the user computing device 11, for example as text and images 23 displayed on the display screen 19 as shown in FIG. 1, in which an instruction to “Drag in the direction shown here” is displayed. Additionally, an image of the key icon 803 and an image of a hand and arrow indicating the direction for the key icon 803 to be dragged on the token device 17 is displayed, i.e. the selected authentication verifier is communicated to the user within the session.

In step 713 the user selects the authentication verifier on the token device 17, i.e. the user interacts with the touch screen 25 in such a way as to drag the key icon in the interactive push overlay notification in the drag direction 801 indicated in the web browser of the user computing device 11.

In step 715 the DSP receives information relating to the selection made on the token device 17, i.e. details of the user interaction with the touch screen 25 and authentication application 614 causes a corresponding notification to be transmitted to the authentication server 15, for example in the form of an activity ID transmitted via the analogue baseband processing unit 510. Optionally, the DPS may also receive corresponding information from one or more inertial measuring units (IMU) 540, for example in the form of readings from accelerometers, gyroscopes, sound cards, and proximity sensors comprised within the token device 17 and the authentication application may also cause details of this information along with the activity ID to be sent to the authentication server 15. For example, when the user interacts with the push screen overlay, motion, velocity, and gesture-based event detection classes of the respective operating system 604 may generate flags corresponding to the interaction of the user, enabling multi-modal sensing of the user interaction with the interactive push overlay.

In step 716, the authentication server 15 receives the information transmitted by the token device 17, for example via network connectivity devices 392 of the authentication server 15, and execution of the software module for performing a user authentication on one or more of the CPUs 382 of one or more of the computing devices cooperating as the authentication server 15 causes the received information to be compared with the stored verification indication (i.e. the stored drag direction) and determines if the activity ID, and therefore the user’s action, is consistent (i.e. matches) the stored verification indicator. If IMU information is also included in the information received from the token device 17, the IMU information may also be processed to determine if the IMU information is also consistent with the stored drag direction 801, thereby corroborating the information regarding the user’s interaction with the screen and providing an additional layer of security.

If the information received from the token device 17 is consistent with the stored drag direction 801 (i.e. the Activity ID is consistent with what was shown in the browser screen to the user), then in step 717, the authentication server transmits an authentication indicator (for example in the form of a digital token) to the application server 13. Likewise, if the Activity ID and/or other information received from the token device 717 is not consistent with the stored drag direction 801, the authentication server 15 may transmit an indication to deny access to the user to the application server.

The authentication server 15 may automatically transmit an indication to deny access to the session user if the response from the token device 17 is not received within a threshold time, thereby effectively giving rise to an expiry for the push notification.

In step 719, upon receipt of the authentication indicator, the web application executed on the application server 13 grants access to secure content of the web application and prevents access to the user otherwise.

Thus, the authentication server 15 provides a second factor authentication process for the web application by requiring a user to perform an interaction on the token device 17 which matches the interaction suggested by the login prompt of the web-browser. Since the suggested interactions are randomly selected for each login attempt, the expected way in which a user will interact with the push notification’s Ul prompt at the token device 17 will vary for the legitimate and non-legitimate login trials; it may be necessary for a user to have sight of both the web-browser on the user computing device 11 and the token device 17 in order to correctly perform the second-factor authentication. In the described embodiment, the authentication server 15 is configured to send push notifications no more frequently than a predetermined time interval, for example 30 seconds, reducing the potential for confusion from multiple pushes launched by an attacker.

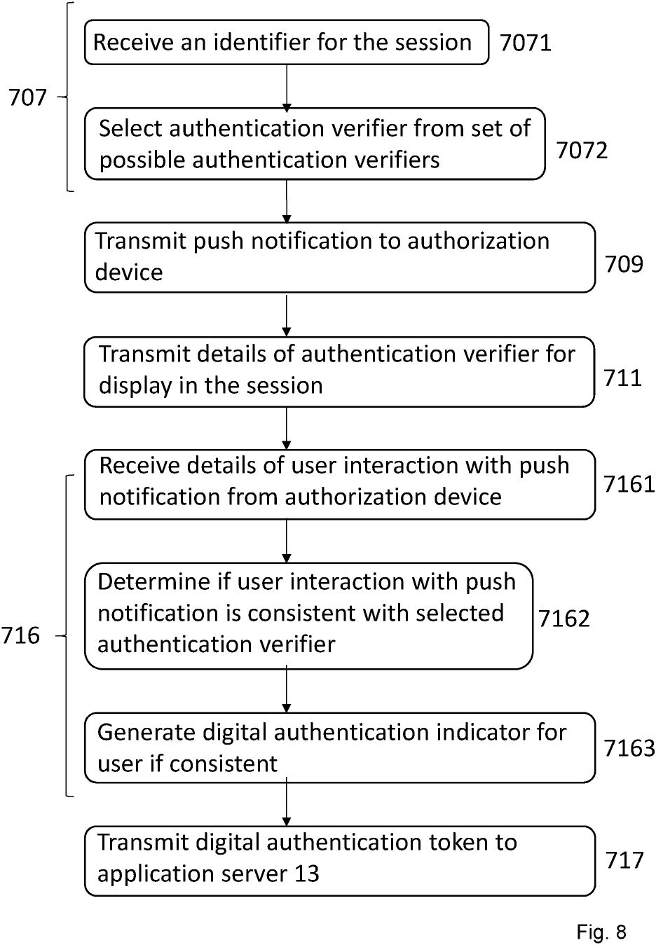

FIG. 8 summarizes the specific steps performed via execution of the software module for performing user authentication on one or more CPUs 382 of the authentication server 15 in the second-factor authentication process including the sub steps of steps 707 and 716.

In step 7071, the authentication server 15 receives details of the session identifier for the session initiated in the web application, the session identifier comprising, for example, the user credentials entered into the login page for the session and looks up the token device 17 associated with the authorized user.

In step 7072, the authentication server 15 selects the authentication verifier from a set of possible authentication verifiers, as described above and stores the selected authentication verifier in one of its memory devices.

Steps 709 and 711 are performed as described above.

In step 7161, the authentication server 15 receives details of the user’s interaction with the push notification on the token device 17, i.e. authentication verifier selection performed on the token device 17.

In step 7162, the authentication server 15 determines if the details of the user’s interaction with the push notification match the stored selected authentication verifier.

In step 7163, the authentication server generates an authentication indicator (for example in the form of a digital token).

Step 717 proceeds as described above.

In order for the token device 17 to be employed as the authentication device in the protocol of FIG. 6, the token device 17 must first be enrolled and associated with the session identifier, for example, the login credentials of the user.

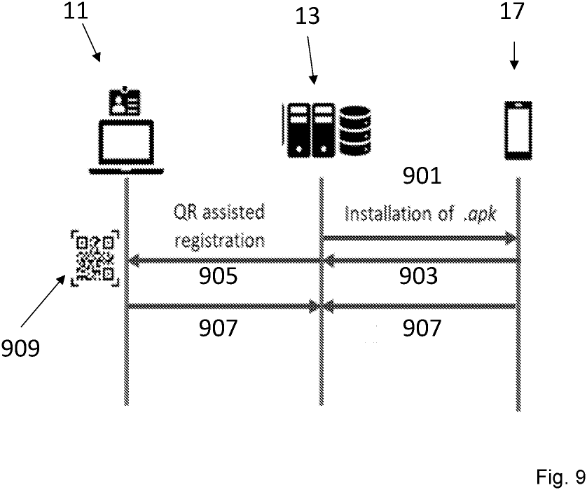

An exemplary protocol for token device 17 enrolment is shown in FIG. 9. For this protocol, the token device 17 is in two-way communication with the application server 13 via a network, for example the internet.

In step 901, the user downloads and installs the authentication application 614 from the application server 13 on to the token device 17, for example in the form of an .apk file.

In step 903, the authentication application 614 is executed by the DSP 502 of the token device 17 and an alert is transmitted to the application server 13.

In step 905, the web application executed on the CPU 382 of the application server 13 prompts the user to enter a session identifier, for example their credentials (such as username and password) into the web browser of the user computing device 11. The web application of the application server 13 also causes a QR code 909 to be displayed in the web browser.

In step 907, the user scans the QR code 909 displayed on the user computing device 11 with the camera 534 of the token device 17. The authentication application 614 causes the token device 17 to then transmit an identifier for itself, such as a device identifier, to the application server 13 and the web application of the application server 13 then binds the session identifier from the browser of the user computing device 11 to the identifier for the token device 17. The application server 13 transmits the pair to the authentication server 15 (not shown in FIG. 9) and the authentication server 15 stores the pair in one of the memory devices of the authentication server 15, for example in the form of a database.

The pair can then be retrieved from memory upon receipt of the user credentials by the application server 13 in steps 703 to 707 of the protocol shown in FIG. 6.

Systems and methods according to the described embodiment are closed-loop feedback-based push TFA solutions which explicitly bind the user session with the push notification by having the user quickly approve the login attempt via replicating the randomized information presented on the browser session over to the login notification, such as by moving a key in a particular direction as in the described embodiment. The user interaction may therefore be very simple and easy while serving to prevent concurrency attacks in which a malicious actor launches a login session at the same time as the user (using, for example stolen credentials), causing two push notifications to be sent to the user’s authentication device at the same time or in quick succession.

Systems and methods according to the described embodiment may enable distinction to be made either by the user or at the authentication server 15 between a legitimate second factor authentication notification and a malicious one as the corresponding verification indicator may be different for each, i.e. the authentication action required to approve the legitimate user’s session may not match with the interaction required to approve the attacker’s session. As only a legitimate user may be able to simultaneously see the login screen and push overlay on the registered token device, an attacker may have no control over what activity is chosen by the authentication server 15.

By randomizing the authentication verifier, different push overlays for concurrent logins would be expected. The legitimate user will be prompted to interact with the push notification in a different manner from that of the attacker’s push notification. Displaying the authentication verifier on the login screen may thus give rise to two particular advantages: a) the user may know what to do with the push prompt on the token device b) if there are concurrent logins, attack, the user may only perform what is shown to the screen before her/him and not the one at attacker’s login screen. Thus, security may be increased without placing a substantial cognitive burden on the user (for example, by having to remember a complicated password) or by having to distinguish between two identical or near-identical notifications.

The system according to the described embodiment also reduces vulnerability to a user habitually confirming a second-factor authentication without sufficient consideration by forcing the user to perform a specific action on the touch screen 25.

Thus, by mapping the login notification to the login session running on the browser, vulnerability to such an attack may be reduced which may improve security.

It may be desirable for servers to deliberately allow concurrent logins by a legitimate user. The present invention may enable such slack to be incorporated into the system without compromising security by enabling the server to distinguish between concurrent attempts by legitimate and illegitimate users.

User experience testing using prototypes of the system 1 indicated that the system according to the described embodiment may be quick and straightforward to use and errors by users (such as inputting the incorrect authentication verifier into the push notification) may be minimal. In addition, the variation in interaction with the push notification with each authentication verifier selection may minimize or avoid habituation by the user, thus enabling to prevent the user inadvertently accepting a push notification sent due to an attacker’s login.

The method according to the described embodiment could be implemented across devices ranging from smartphones, smart-watches to other forms of wearables without any dependencies and could be employed to protect a variety of secure content including but not limited to mailing services, web portals and streaming services, databases, content sharing platforms, fintech transactions, secure access to government services, cloud access platforms, medical databases, critical infrastructure control centres and /or any industry where data security is important.

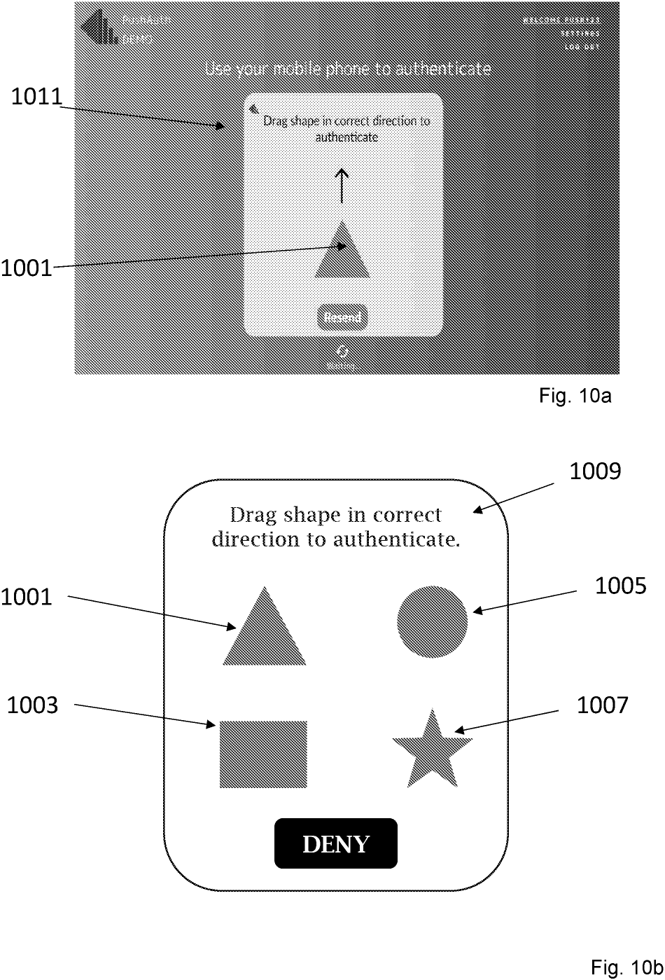

The described embodiment should not be construed as limitative. It is envisaged that alternative authentication verifiers could be employed. FIGS. 10a and 10b show an authentication verifier according to a second embodiment, based on selecting and dragging a particular shape, with an example login prompt 1011 (with selected authentication verifier 1001) for display on the user computing device 11 illustrated in FIG. 10a and corresponding interactive push overlay 1009 for display on the token device 17 such as a smartphone (not shown for simplicity) illustrated in FIG. 10b. The set of authentication verifiers includes a set of four objects in the form of four different shapes: a triangle 1001, a circle 1005, a square 1003 and a star 1007 (all displayed in the interactive push overlay 1009) as well as a set of drag directions, analogous to those for the described embodiment above, as illustrated in FIG. 7.

In use, therefore, the software module for performing the user authentication method executed on one or more CPUs 382 of the authentication server 15 selects one of the shapes and a drag direction as the authentication verifier and causes the drag direction to be displayed on the user computing device 11. In the example shown in FIG. 10a, the triangle 1001 and upwards direction have been selected. In order to successfully perform the second factor authentication on the interactive push overlay 1009, the user must select the authentication verifier shown in FIG. 10a and drag the triangle 1001 in an upwards direction using touch screen 25.

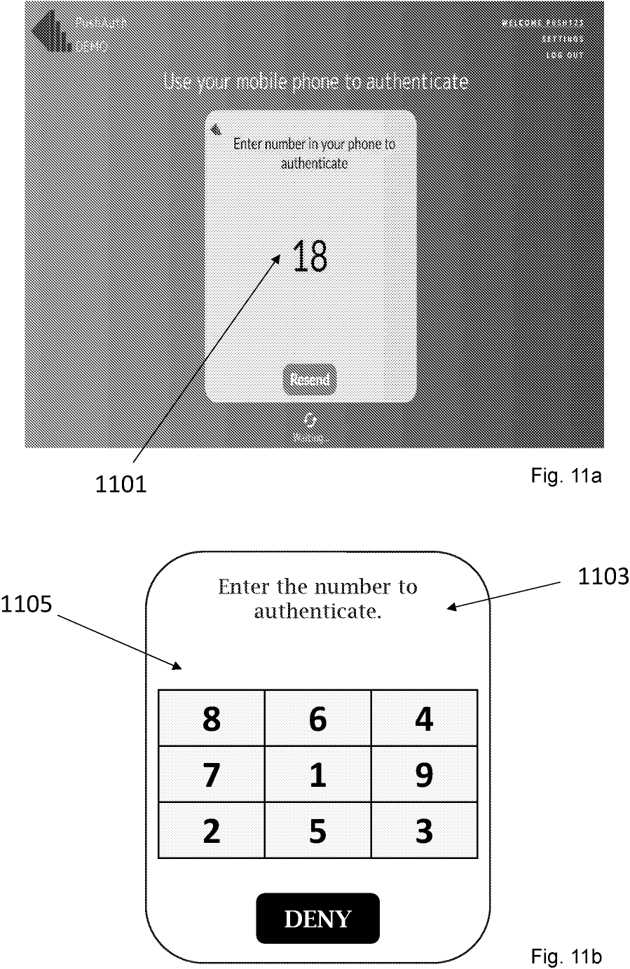

FIGS. 11a and 11b show an authentication verifier according to a third embodiment, based on entering a randomly selected two-digit number into a randomized numerical keypad, with an example login prompt (with selected authentication verifier 1101) for display on the user computing device 11 illustrated in FIG. 11a and corresponding interactive push overlay 1103 for display on the token device 17 illustrated in FIG. 11b (note that the token device 17 itself is not shown for simplicity). The set of authentication verifiers includes numbers, specifically two-digit numbers in the described embodiment, and the interactive push overlay 1103 includes a numerical keypad 1105 including numbered buttons provided in a random order for receiving the user input number, i.e. the authentication verifier selected by the user at the token device 17.

In use, therefore, as a result of executing the software module for performing the user authentication method, one or more CPUs 382 of the authentication server 15 randomly generates a numeric key as the authentication verifier and causes the numeric key to be displayed on the user computing device 11. In the example shown in FIG. 11a, number 18 has been selected. In order to successfully perform the second factor authentication on the interactive push overlay 1103, the user must enter the number 18, i.e. select the authentication verifier 1101 shown in FIG. 11a using the randomized numerical keypad 1105 on touch screen 25.

In a variation to the third embodiment, a longer number may be employed. For example, a number comprising from 2 to 4 digits may be employed as the authentication verifier, such as a 3 digit number.

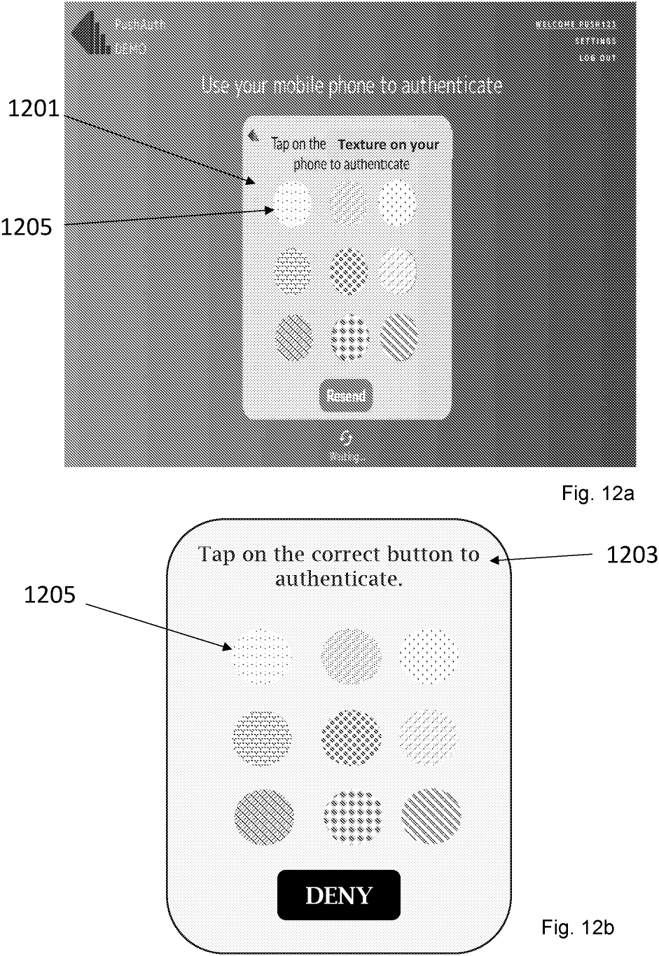

FIGS. 12a and 12b show an authentication verifier according to a fourth embodiment, based on selecting a particular patterned or coloured button, with an example login prompt 1201 for display on the user computing device 11 illustrated in FIG. 12a and corresponding interactive push overlay 1203 shown in FIG. 12b (note that the token device 17 itself is not shown for simplicity). Note that different patterned, equivalently different textured buttons are illustrated in FIGS. 12a and 12b for clarity however it will be appreciated that the buttons could additionally or alternatively be distinguished from each other in some other way, for example by having different colours. The set of authentication verifiers includes nine buttons, each having a different pattern. The full set of buttons is displayed both in the login prompt 1201 and interactive push overlay 1203.

In use, therefore, the software module for performing the user authentication method causes one or more CPUs 382 of authentication server 15 to randomly select a particular patterned button as the authentication verifier and causes instructions for user to select this button to be displayed in the login prompt 1201 of the user computing device 11. In the example shown in FIG. 12a, for example, the spotted button 1205 may be selected. In order to successfully perform the second factor authentication on the interactive push overlay 1203 in such a case, the user must tap on the spotted button 1205 using touch screen 25.

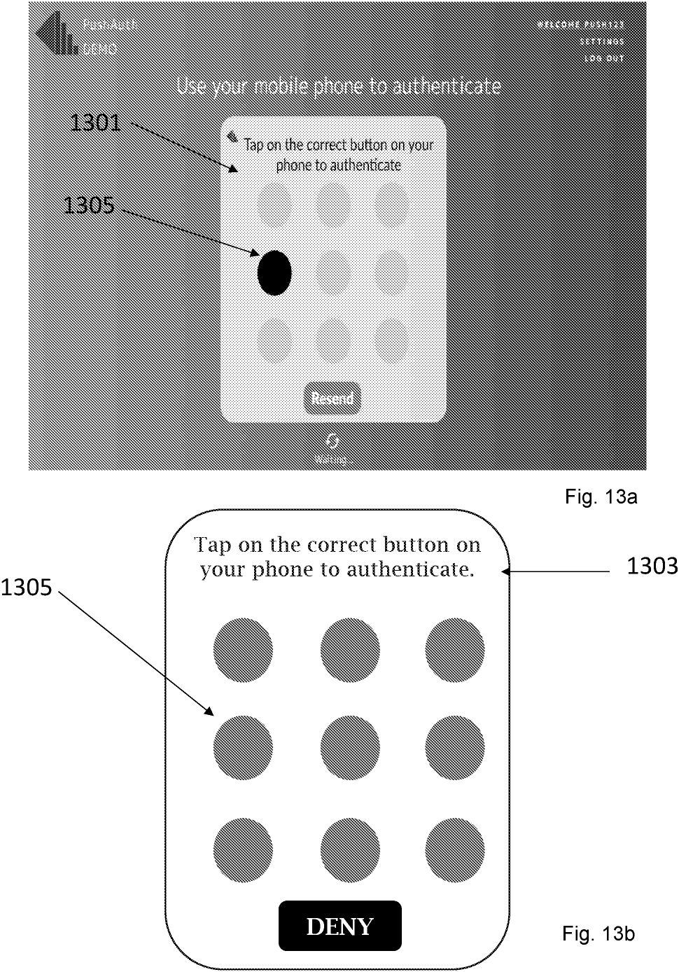

FIGS. 13a and 13b show an authentication verifier according to a fifth embodiment, based on selecting a highlighted button, with an example login prompt 1301 for display on the user computing device 11 illustrated in FIG. 13a and corresponding interactive push overlay 1303 for display on the token device 17 illustrated in FIG. 13b (note that the token device 17 itself is not shown for simplicity). The set of authentication verifiers includes nine buttons. The full set of buttons is displayed both in the login prompt 1301 and interactive push overlay 1303.

In use, therefore, as a result of executing the software module for performing the user authentication method, one or more CPUs 382 of the authentication server 15 randomly selects one of the nine buttons as the authentication verifier and highlights the button 1305 in black in order to indicate to the user to select this button in the login prompt 1301 for display on the user computing device 11. In order to successfully perform the second factor authentication on the interactive push overlay 1303 and select the authentication verifier, the user must tap on the button 1305 using touch screen 25.

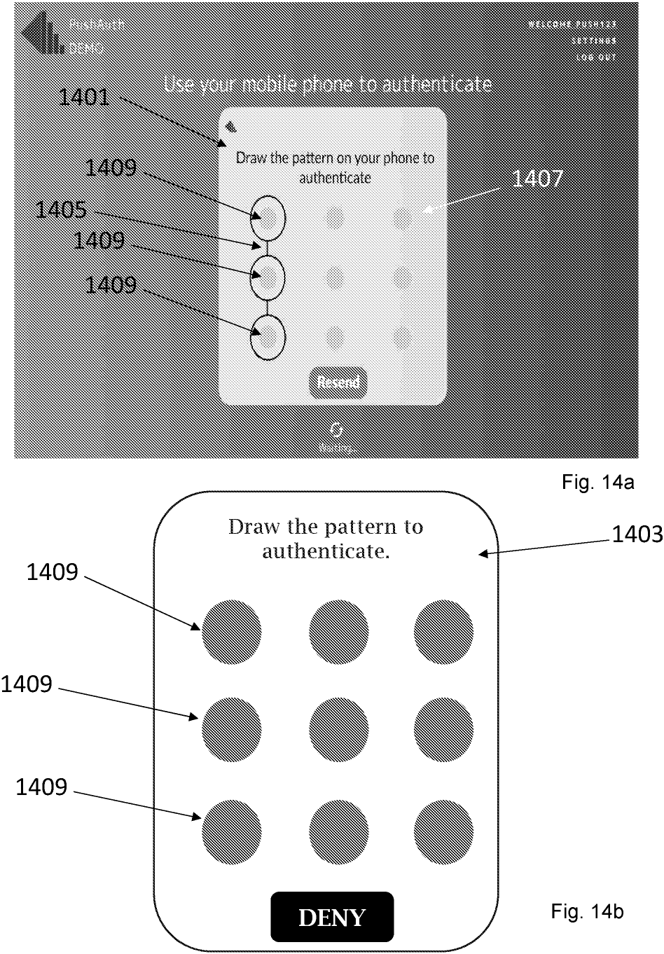

FIGS. 14a and 14b show an authentication verifier according to a sixth embodiment, based on drawing a pattern, with an example login prompt 1401 for display on the user computing device 11 illustrated in FIG. 14a and corresponding interactive push overlay 1403 for display on the token device 17 illustrated in FIG. 14b (note that the token device 17 itself is not shown for simplicity). The set of authentication verifiers includes a finite number of patterns which may be formed by joining two or more of nine circles arranged in three rows of three in a square configuration 1407. The nine circles are displayed both in the login prompt 1401 and interactive push overlay 1403.

In use, therefore, as a result of executing the software module for performing the user authentication method, one or more CPUs 382 of the authentication server 15 randomly selects one of the predetermined set of patterns as the authentication verifier and indicates the selected pattern 1405 by joining the relevant circles in order to indicate to the user to draw the same pattern on the interactive push overlay 1403 for display on the user computing device 11. In the example shown in FIG. 14a, the selected pattern consists of joining the three circles 1409 aligned on the left-hand side of the square 1407. In order to successfully perform the second factor authentication on the interactive push overlay 1403, the user must select the authentication verifier shown in FIG. 14a by drawing the pattern 1405, for example by dragging their finger in a straight line either up or down the three circles 1409 on the touch screen 25.

In a seventh embodiment, the set of authentication verifiers may include a set of images. A grid of images taken from the set is displayed in the push notification and the login screen prompts the user to select one of the images as the authentication verifier.

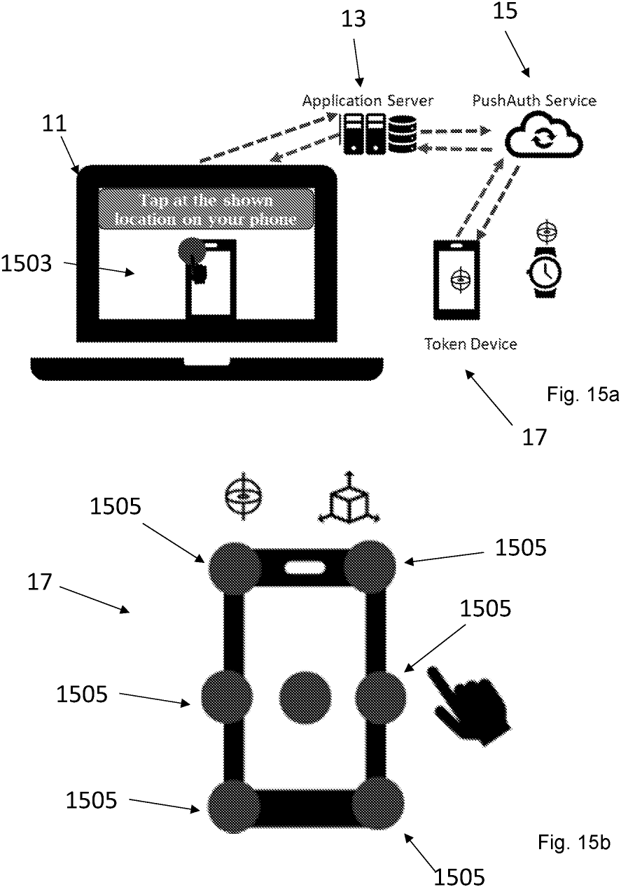

FIGS. 15a and 15b show an authentication verifier according to a sixth embodiment, based on tapping a location on the token device 17 with an example login prompt 1503 for display on the user computing device 11 illustrated in FIG. 15a. The set of authentication verifiers includes a finite number of locations 1505 which may be tapped on the token device 17, as illustrated in FIG. 15b in order to select the authentication verifier.

In this embodiment, the tap location may be sensed entirely using one or more IMUs of the token device 17. Consequently, there is no requirement for the user to unlock the token device 17. In this embodiment, a notification may still be sent to the token device, although it is not necessary for the notification to have a user interface. Nevertheless, the provision of a user interface may provide confidence to the user and therefore may still be employed.

In an embodiment, the user or an administrator may have the option of selecting one of the authentication verifier sets according to the above described embodiments or preferred sets of authentication verifiers from the above described embodiments according to personal preference, frequency of use, and/or security requirements.

It is envisaged that authentication verifiers other than those described above could be employed according to an embodiment. It is envisaged that greater or fewer authentication verifiers could be provided for selection at the token device 17. For example, at least two authentication verifiers may be provided for selection at the token device 17, such as from about 8 to about 100 authentication verifiers.

It is envisaged that for any of the embodiments described above, the authentication verifier could be selected by a means other than random selection by one or more CPUs 382 of the authentication server 15. For example, the authentication verifier could be selected by the user themselves via a user interface displayed in the web browser. The authentication verifier could be partially selected by executing the software module for performing the user authentication method on the authentication server 15 and partly by the user, for example, one or more CPUs 382 of the authentication server 15 could select a sub-set of authentication verifiers and the user could select the authentication verifier from the sub-set of authentication verifiers.

Although the user is described as initiating the session on a user computing device 11 in the form of a personal computer and having components shown in FIG. 2, it is envisaged that the user computing device 11 could instead comprise a mobile device having components as described in regard to FIG. 3, including (but not limited to) a mobile device which also functions as the authentication device.

Likewise, although the token device 17 is described as being a mobile device, the token device 17 could instead comprise a computing device having components as described in regard to FIG. 2.

It is envisaged that the authentication server 15 may not be provided separately from the application server 13 and may be comprised within it. Alternatively, the functionality of authentication server 15 may be performed using software installed on the user computing device 11. Indeed, the use of the term ‘server’ may mean both hardware or software (computer program) that provides functionality for other programs or devices, generally called ‘clients’.

The user computing device 11, application server 13 and one or more computing resources in the authentication server 15 may include more or fewer components, or alternative components than indicated in FIG. 2. Likewise, the token device 17 (and any other token devices employed in the system 1) may include more or fewer components than indicated in FIG. 3 and/or may have software environments which differ from those shown in FIGS. 4 and 5. The functionality of the authentication server 15 may be performed by a single computing device 380, rather than performed in a cloud computing environment.

It is envisaged that the authentication device may not comprise a token device (i.e. a peripheral device without a physical connection to the user computing device 11). For example, the authentication device may be the user computing device 11 on which the session is initiated itself.

It is envisaged that the authentication verification may not require a dedicated application such as the authentication application 614; its functionality may instead be integrated with another application such as a third-party application.

Although QR code-based registration is described above, it is envisaged that any method which enables the application server 13 to bind the login credentials with an identifier of an authentication device may be employed.

The login session initiated by the user may not be initiated in a web-browser but in another application hosted by the application server 13. Alternatively, the application may not require an application server 13.

It is envisaged that the that user computing device 19 may communicate directly with the authentication server 15, i.e. not via the application server 13.

It is envisaged that the set of authentication verifiers could itself be randomly selected for each log-in attempt from a superset comprising a plurality of sets of authentication verifiers for potential added security and randomization. For example, the authentication server may select between the key drag of the first embodiment (see FIG. 7), entering a two-digit number (see FIGS. 11a and 11b) and selecting a coloured circle (see FIGS. 12a and 12b), thus adding an additional layer of randomization into selecting the authentication verifiers. In this variation, the interactive push overlay is varied so that the user interface provided by the interactive push overlay corresponds to the selected set of authentication verifiers.

It is envisaged that the user interface for making the selection of the authentication verifier on the token device 17 may not be provided in a push overlay notification and instead be provided, for example in an application installed on the token device 17.

While in several of the embodiments described above, the user interaction is described as being via the touchscreen with a graphical user interface, with optional additional sensing via IMUs in the token device, it is envisaged that the user activity on the token device could instead be entirely detected using IMU data and, as such, it may not be necessary for the push notification to provide a graphical user interface although, as noted above, the provision of a user interface may provide confidence to the user and therefore may still be employed in such variations. Alternatively, or additionally, the user selection at the token device may be performed at least in part using an additional peripheral or built-in component of the token device, such as a physical keyboard or mouse.

Having now fully described the invention, it should be apparent to one of ordinary skill in the art that many modifications can be made hereto without departing from the scope as claimed.

1. A method of authenticating a session user in a session initiated on a computing device, comprising:
(i) identifying an authentication device associated with an identifier for the session;
(ii) identifying a selection of an authentication verifier from a set of possible authentication verifiers for the session, the selected authentication verifier being communicated within the session to the session user;
(iii) providing at least two of the set of possible authentication verifiers for selection at the authentication device for the session, the at least two of the set of possible authentication verifiers including the selected authentication verifier;
(iv) receiving an authentication device selection from the authentication device by a user’s selection from the at least two of the set of possible authentication verifiers; and
(v) determining if the authentication device selection matches the selected authentication verifier as communicated within the session.

2. The method of authenticating a session user in a session initiated on computing device according to claim 1, wherein identifying the selection of the authentication verifier from the set of possible authentication verifiers for the session includes selecting the authentication verifier from the set of possible authentication verifiers for the session.

3. The method of authenticating a session user in a session initiated on computing device according to claim 2, wherein selecting the authentication verifier from the set of possible authentication verifiers for the session includes randomly selecting the authentication verifier from the set of possible authentication verifiers for the session.

4. The method of authenticating a session user in a session initiated on the computing device according to claim 1, wherein identifying the selection of the authentication verifier from the set of possible authentication verifiers for the session includes receiving the selection of the authentication verifier by the session user.

5. The method of authenticating a session user in a session initiated on a computing device according to claim 1, wherein providing at least two of the set of possible authentication verifiers for selection at the authentication device for the session comprises providing from 8 to 100 of the set of possible authentication verifiers for the session for selection at the authentication device.

6. The method of authenticating a session user in a session initiated on a computing device according to claim 1, wherein providing at least two of the set of possible authentication verifiers for selection at the authentication device for the session comprises providing a graphical user interface operable to receive the authentication device selection.

7. The method of authenticating a session user in a session initiated on a computing device according to claim 6, wherein the graphical user interface is provided in the form of an interactive push overlay notification to the authentication device.

8. The method of authenticating a session user in a session initiated on a computing device according to claim 1, wherein each of the set of possible authentication verifiers comprises a different respective drag direction for at least one object, and wherein providing at least two of the set of possible authentication verifiers for selection at the authentication device for the session includes providing the at least one object for display at the authentication device.

9. The method of authenticating a session user in a session initiated on a computing device according to claim 8, wherein each of the set of possible authentication verifiers comprises a respective drag direction for a respective object of a plurality of objects, and wherein providing at least two of the set of possible authentication verifiers for selection at the authentication device includes providing the plurality of objects for display at the authentication device.

10. The method of authenticating a session user in a session initiated on a computing device according to claim 1, wherein each of the set of possible authentication verifiers comprises a different respective number and wherein providing at least two of the set of possible authentication verifiers for selection at the authentication device includes providing an interface operable to receive a numerical input at the authentication device.

11. The method of authenticating a session user in a session initiated on a computing device according to claim 10, wherein providing the interface operable to receive the numerical input at the authentication device includes providing a numerical keypad for display at the authentication device.

12. The method of authenticating a session user in a session initiated on a computing device according to claim 1, wherein each of the set of possible authentication verifiers comprises a different respective button of a plurality of buttons and wherein providing at least two of the set of possible authentication verifiers for selection at the authentication device includes providing at least two of the plurality of buttons for display at the authentication device.

13. The method of authenticating a session user in a session initiated on a computing device according to claim 1, wherein each of the set of possible authentication verifiers comprises a different respective pattern and wherein providing at least two of the set of possible authentication verifiers for selection at the authentication device comprises providing an interface operable to receive a user drawing of a selected pattern at the authentication device.

14. The method of authenticating a session user in a session initiated on a computing device according to claim 1, wherein the each of the set of possible authentication verifiers comprises a different respective location on the authentication device to be tapped.

15. The method of authenticating a session user in a session initiated on a computing device according to claim 1, further comprising selecting the set of possible authentication verifiers from a superset comprising a plurality of sets of possible authentication verifiers.

16. The method of authenticating a session user in a session initiated on a computing device according to claim 1, wherein the authentication device comprises at least one inertial measuring unit and wherein receiving an authentication device selection from the authentication device includes receiving data from the at least one inertial measuring unit.

17. The method of authenticating a session user in a session initiated on a computing device according to claim 16, wherein the authentication device comprises a plurality of inertial measuring units and wherein receiving an authentication device selection from the authentication device includes receiving data from each of the plurality of inertial measuring units.

18. Method The method of authenticating a session user in a session initiated on computing device according to claim 1, wherein the authentication device comprises a token device.

19. (canceled)

20. (canceled)

21. (canceled)

22. A method of authenticating a session user in a session initiated on a computing device, the method comprising:
identifying, by an authentication server, an authentication device associated with an identifier for the session;
identifying, by the authentication server, a selection of an authentication verifier from a set of possible authentication verifiers for the session;
communicating, by the authentication server, the selected authentication verifier within the session to the computing device of the session user;
providing at least two of the set of possible authentication verifiers by the authentication server including the selected authentication verifier for selection at the authentication device:
receiving, by the authentication device, an authentication device selection by a user’s selection from the at least two of the set of possible authentication verifiers;
receiving, by the authentication server, the authentication device selection from the authentication device; and
determining, by the authentication server, if the authentication device selection matches the selected authentication verifier as communicated within the session.

23. (canceled)

24. (canceled)

25. (canceled)

26. (canceled)

27. (canceled)

28. (canceled)

29. A system for authenticating a session user in a session, the session comprising an identifier, the system comprising:
a computing device configured to initiate the session;
an authentication device associated with the identifier; and
an authentication server communicatively coupled to the computing device and the authentication device, and configured to:
identify the authentication device from the identifier for the session,
identify a selection of an authentication verifier from a set of possible authentication verifiers for the session,
communicate the selected authentication verifier within the session to the computing device of the session user:
communicate at least two of the set of possible authentication verifiers including the selected authentication verifier to the authentication device for selection at the authentication device;
wherein the authentication device is arranged to receive a user’s selection of an authentication device selection from the at least two of the set of possible authentication verifiers and to communicate the authentication device selection to the authentication server; and
wherein, the authentication server is further configured to determine if the authentication device selection matches the selected authentication verifier as communicated within the session.

30-40. (canceled)
